(19) United States
(12) Patent Application Publication
(10) Pub. No.: US 2013/0259009 A1
(43) Pub. Date: Oct. 3, 2013

(54) System and Method for Transmitting a Reference Signal

(71) Applicant: FUTUREWEI TECHNOLOGIES, INC., Plano, TX (US)

(72) Inventors: Fredrik Berggren, Upplands Vaesby (SE); Brian Classon, Palatine, IL (US)

(73) Assignee: FUTUREWEI TECHNOLOGIES, INC., Plano, TX (US)

(21) Appl. No.: 13/803,649

(22) Filed: Mar. 14, 2013

Related U.S. Application Data
(60) Provisional application No. 61/617,515, filed on Mar. 29, 2012.

(51) Int. Cl. H04W 72/04

(52) U.S. Cl. CPC H04W 72/0446
USPC 370/336

(57) ABSTRACT

In one embodiment, a method for transmitting a reference signal in a wireless communications system includes obtaining, by a base station, a radio frame and determining, by the base station, a first subset of subframes of the radio frame, where the first subset includes a first subframe of the radio frame, and where the first subframe includes a mandatory downlink signal. Also, the method includes transmitting the reference signal only in the determined first subset.

This application claims the benefit of U.S. Provisional Application No. 61/617,515 filed on Mar. 29, 2012, entitled “System and Method for Transmitting a Reference Signal,” which is incorporated herein by reference as if reproduced in its entirety.

### TECHNICAL FIELD

The present invention relates to a system and method for wireless communications, and, in particular, to a system and method for transmitting a reference signal.

### BACKGROUND

A receiver, also known as a user equipment (UE), a mobile station, a wireless terminal and/or a mobile terminal is enabled to communicate wirelessly in a wireless communication system, sometimes also referred to as a cellular radio system. The communication may be made, e.g., between two receivers, between a receiver and a wire connected telephone and/or between a receiver and a server via a Radio Access Network (RAN) and possibly one or more core networks.

The receiver may further include a mobile telephone, a cellular telephone, a computer tablet or a laptop with wireless capability. The UEs in the present context may be, for example, a portable, pocket-storable, hand-held, computer, or vehicle-mounted mobile devices, enabled to communicate voice and/or data, via the radio access network, with another entity, such as another receiver or a server.

The wireless communication system covers a geographical area which is divided into cell areas, with each cell area being served by a radio network node, or base station, e.g., a radio base station (RBS), which in some networks may be referred to as a transmitter, “eNB,” “eNodeB,” “NodeB,” or “B node,” depending on the technology and terminology used. Sometimes, the term “cell” may also be used for denoting the radio network node itself. However, the term “cell” may also refer to the geographical area where radio coverage is provided by the radio network node/base station at a base station site. One radio network node, situated on the base station site, may serve one or several cells. The radio network nodes communicate over the air interface operating on radio frequencies with the receivers within range of the respective radio network node.

In some radio access networks, several radio network nodes may be connected, e.g., by landlines or microwave, to a Radio Network Controller (RNC), e.g., in Universal Mobile Telecommunications System (UMTS). The RNC, also sometimes termed Base Station Controller (BSC), e.g., in Global System for Mobile Communications (GSM), may supervise and coordinate various activities of the plural radio network nodes connected thereto.

### SUMMARY

An embodiment method for transmitting a reference signal in a wireless communications system includes obtaining, by a base station, a radio frame and determining, by the base station, a first subset of subframes of the radio frame, where the first subset includes a first subframe of the radio frame, and where the first subframe includes a mandatory downlink signal. Also, the method includes transmitting the reference signal only in the determined first subset.

An embodiment base station includes a processor and a computer readable storage medium storing programming for execution by the processor. The programming includes instructions to obtain a radio frame and determine a first subset of subframes of the radio frame, where the first subset includes a first subframe of the radio frame, and where the first subframe includes a mandatory downlink signal. Also, the base station includes a transmitter coupled to the processor, where the transmitter is configured to transmit a reference signal in the determined first subset.

Another embodiment method for receiving a reference signal in a wireless communications system includes obtaining, by a user equipment, a radio frame and determining, by the user equipment, a subset of subframes of the radio frame, where the subset includes a first subframe of the radio frame, and where the first subframe includes a mandatory downlink signal. Also, the method includes receiving the reference signal only in the determined subset.

An embodiment user equipment includes a processor and a computer readable storage medium storing programming for execution by the processor. The programming includes instructions to obtain, by the user equipment, a radio frame and determine, by the user equipment, a subset of subframes of the radio frame, where the subset includes a first subframe of the radio frame, and where the first subframe includes a mandatory downlink signal. Also, the programming includes instructions to receive a reference signal only in the determined subset.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an FDD frame structure used by an LTE system;

FIG. 2 illustrates a TDD frame structure used by an LTE system;

FIG. 3 illustrates a flowchart of an embodiment method for transmitting a reference signal;

FIG. 4 illustrates a flowchart of an embodiment method for receiving a reference signal;

FIG. 5 illustrates a block diagram of an embodiment base station; and

FIG. 6 illustrates a block diagram of an embodiment user equipment.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In 3rd Generation Partnership Project (3GPP) Long Term Evolution (LTE), radio network nodes, which may be referred to as eNodeBs or eNBs, may be connected to a gateway, e.g., a radio access gateway, or to one or more core networks.

In the present context, the expressions “downlink,” “downstream link,” or “forward link” may be used for the transmission path from the radio network node to the receiver. The terms “uplink,” “upstream link,” or” reverse link” may be used for the transmission path in the opposite direction, i.e., from the receiver to the radio network node.

Orthogonal frequency division multiplexing (OFDM) is a method of encoding digital data on multiple carrier frequencies. OFDM is a Frequency-Division Multiplexing (FDM) scheme used as a digital multi-carrier modulation method. A large number of closely spaced orthogonal sub-carrier signals are used to carry data. The data is divided into several parallel data streams or channels, one for each sub-carrier. OFDM has developed into a popular scheme for wideband digital communication, whether wireless or over copper wires, and it is used in applications such as digital television and audio broadcasting, Digital Subscriber Line (DSL) broadband internet access, wireless networks, and 4G mobile communications.

In LTE, the smallest time-frequency entity that can be used for transmission is referred to as a Resource Element (RE), which may convey a complex-valued modulation symbol on a subcarrier. In this context, the RE may be referred to as time-frequency resources. A Resource Block (RB) comprises a set of resource elements or a set of time-frequency resources and is of 0.5 ms duration (e.g., 7 OFDM symbols) and 180 kHz bandwidth (e.g., 12 subcarriers with 15 kHz spacing). The LTE standard refers to a Physical Resource Block (PRB) as a resource block where the set of OFDM symbols in the time-domain and the set of subcarriers in the frequency domain are contiguous. The LTE standard further defines Virtual Resource Blocks (VRBs) which can be of either localized or distributed type. The transmission bandwidth of the system is divided into a set of resource blocks. Typical LTE carrier bandwidths correspond to 6, 15, 25, 50, 75 and 100 resource blocks. A transmission of user data on the Physical Downlink Shared Channel (PDSCH) can be performed over 1 ms duration, which is also referred to as a subframe, on one or several resource blocks. A radio frame consists of 10 subframes (enumerated from 0 to 9), or alternatively, of 20 slots of 0.5 ms length (enumerated from 0 to 19).

A method for generating patterns for a reference signal was described in U.S. Patent Application No. 61/617,515, US Publication Number 2012/0020302, by Weimin Xiao, filed on Oct. 3, 2011, entitled “Method and Apparatus for Generating Time-Frequency Patterns for Reference Signal in an OFDM Wireless Communication System,” which is hereby incorporated by reference.

The wireless communication system may be configured to operate according to the Time Division Duplex (TDD) and/or the Frequency Division Duplex (FDD) principle. TDD is an application of time-division multiplexing to separate uplink and downlink signals in time, possibly with a guard period situated in the time domain between the uplink and downlink signaling. In FDD, the transmission and reception are at different carrier frequencies.

In a 3GPP LTE system, multiple transmit and receive antennas are supported, and the notion of an antenna port is used. Each downlink antenna port is associated with a unique reference signal. An antenna port may not necessarily correspond to a physical antenna, and one antenna port may be associated with more than one physical antenna. The reference signal on an antenna port may be used for channel estimation for data that is transmitted on the same antenna port.

A number of reference signals have been defined in the LTE downlink, e.g., a Common Reference Signal (CRS). A CRS is a cell-specific reference signal, which is transmitted in all subframes (i.e., for TDD, all downlink subframes) and in all resource blocks of the carrier. The CRS is transmitted on a subset of the available resource elements in a resource block according to predefined patterns. The CRS serves as a reference signal for several purposes such as, e.g., channel estimation for demodulation, channel state information measurements, time- and frequency synchronization, Radio Resource Management (RRM) and/or mobility measurements.

Up to 4 CRS antenna ports may be accommodated and a cell may be configured with ports p=0 or p=0, 1 or p=0, 1, 2, 3. The CRS has a sufficient number of resource elements to provide for multiple purposes, e.g., phase- and amplitude reference for channel estimation for data demodulation of UE-specific data (e.g., the physical downlink shared channel (PDSCH)), synchronization, and RRM measurements.

During the initial access of a receiver/mobile terminal in a wireless communication system, a connection is established by first detecting and synchronizing to the cell. In a 3GPP LTE system, the receiver establishes a connection to a cell/radio network node by performing cell search and synchronization using primary and secondary synchronization signals. The receiver may then continuously try to keep the time- and frequency synchronization to the cell, and it may additionally use the reference signals (i.e., CRS) for this purpose. Once the cell ID has been found and synchronization been established by the receiver, a Physical Broadcast Channel (PBCH) is detected. The PBCH includes a minimum amount of information for the receiver to be able to proceed receiving other data channels and start camping on the cell.

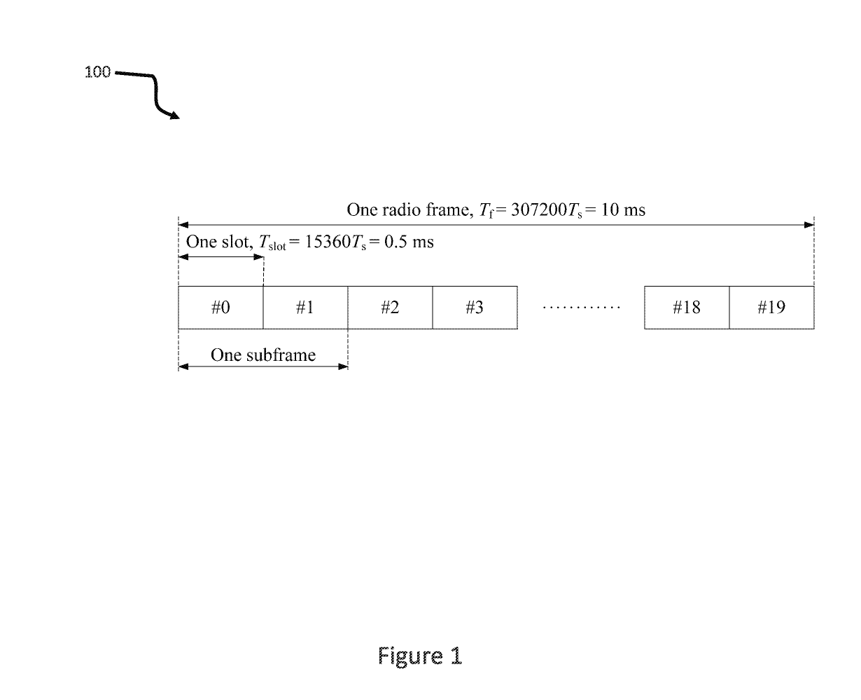

FIG. 1 illustrates a radio frame for a TDD LTE system 100. A TDD radio frame may, for example, last for 10 ms. In an example, the radio frame is divided into divided into ten subframes of, for example, 1 ms each, while each subframe is divided into two slots of, for example, 0.5 ms.

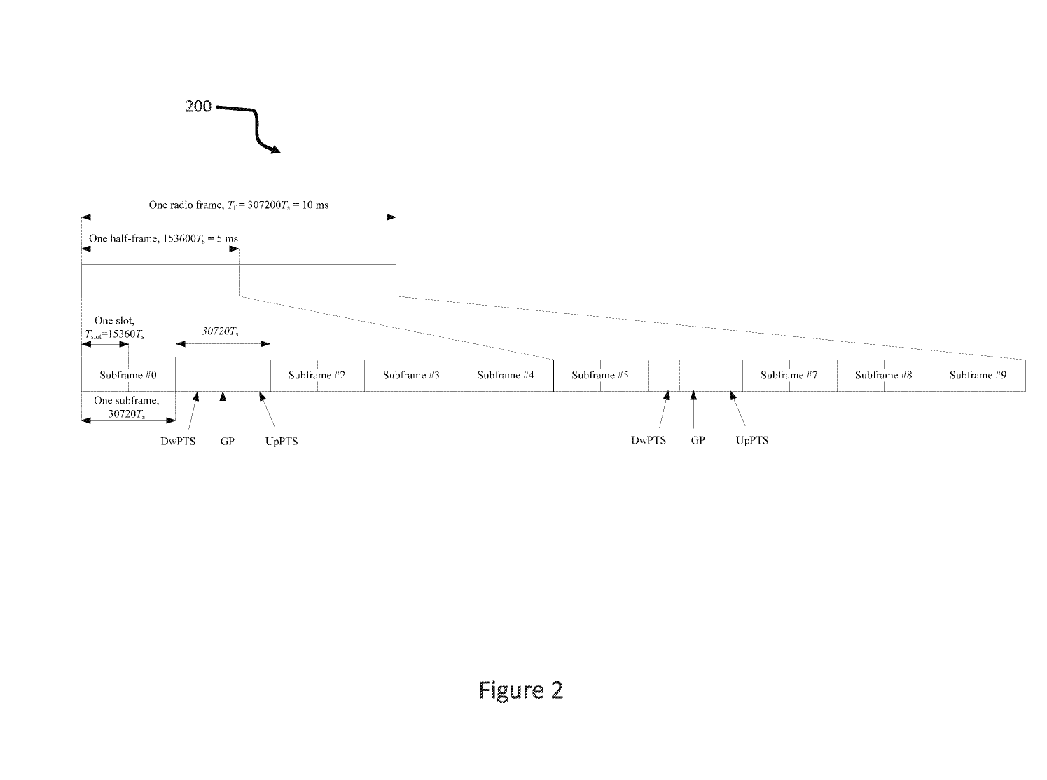

Similarly, FIG. 2 illustrates a radio frame for a TDD LTE system 200. In an example, a TDD radio frame contains ten subframes, with each subframe containing a set of OFDM symbols (e.g., 6 or 7 OFDM symbols). The radio frame is 10 ms, consisting of two half frames of 5 ms each. Subframe one is a special subframe and subframe six may be a special subframe. Each special subframe contains a downlink pilot time slot (DwPTS), a guard period (GP), and an uplink pilot time slot (UpPTS). While some embodiments are described for an LTE system, other telecommunications systems may be used.

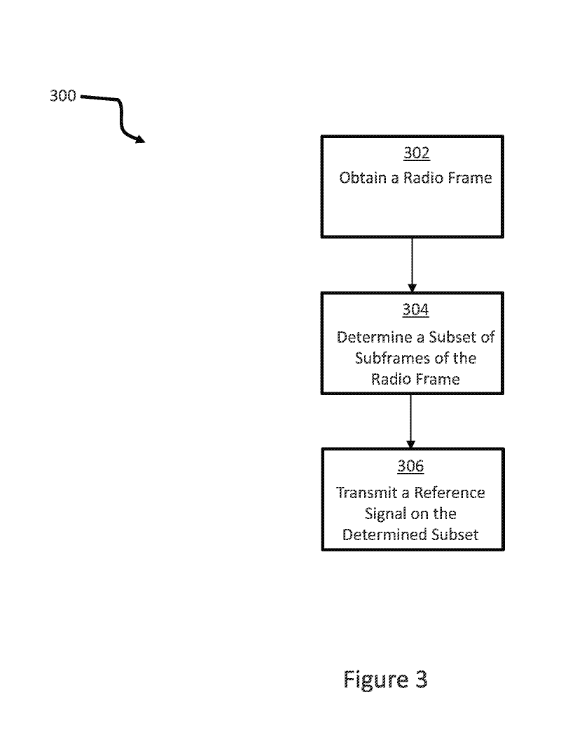

FIG. 3 illustrates flowchart 300 for an embodiment method of transmitting a reference signal. Initially, in step 302, a transmitter obtains a radio frame to be transmitted. Next in step 304, the transmitter determines a subset of subframes of the radio frame encompassing time-frequency resources to transmit a reference signal on. Finally, in step 306, a reference signal in the determined subset of the radio frame is transmitted by the transmitter. In an example, the reference signal provides for synchronization and/or RRM measurements, but does not provide for channel estimation for data demodulation of UE-specific data (e.g., the physical downlink shared channel (PDSCH)). Also, in one example, the reference signal has the same time-frequency position (i.e., using the same resource elements) and modulation symbols as the common reference signal (CRS) in an LTE system.

Determining a subset of subframes of the radios frame to transmit the reference signal on may be performed in a variety of ways. Determining a subset of subframes may include defining or arranging the determined subset of subframes when the determined subset of subframes is predetermined or predefined. In some examples, the reference signal may be transmitted in one subframe per radio frame, in two subframes per radio frame, or in three subframes per radio frame. The determined subset of subframes may include a subframe that contains a mandatory downlink signal or channel. Such a signal/channel may have to be transmitted by the system on a set of predefined resource elements. Mandatory downlink signals or channels in LTE systems may include a primary synchronization signal (PSS), a secondary synchronization signal (SSS), and/or a physical broadcast channel (PBCH), or the like. The CRS may also be regarded as a mandatory signal in that it is cell-specific and transmitted in every subframe. The base station transmits on the predefined resource elements according to the standard specification. In an FDD LTE system, the PSS and SSS are transmitted on subframes zero and five, where the PSS is transmitted on the OFDM symbol immediately following the SSS. However, in a TDD LTE system, the SSS is transmitted on subframes zero and five, and the PSS is transmitted on subframes one and six, where the PSS is transmitted three OFDM symbols after the SSS. If subframe one or six is a special subframe, the PSS is transmitted in the DwPTS field. Alternatively, the determined subset of subframes is another configuration of subframes where the determined subset of subframes includes subframes having a mandatory downlink signal or channel.

In one embodiment, the power consumption of the transmitter is reduced, because there are subframes for which no channels or signals are transmitted, and the power amplifier can be turned off. Having consecutive subframes that are transmitting any mandatory signals minimizes the power amplifier switching time, prolongs the OFF period, and consequently reduces its duty cycle. In another embodiment, the power consumption in the receiver for processing the reference signal is reduced. During periods of low activity, in order to save power, a system may configure a UE to utilize Discontinuous Reception (DRX), during which the UE is in sleep mode, and only occasionally wakes up to monitor signals and channels in the downlink, e.g., to maintain synchronization to the cell.

In one embodiment, the reference signal is transmitted in the vicinity of the mandatory signals. For example, the reference signal is transmitted in the same subframes as at least one mandatory signal. This reduces the duty cycle of the transmitter, and saves transmit power because of longer OFF periods for the power amplifier. Similarly, it reduces the amount of time a receiver needs to be on to receive signals in the downlink. For example, the reference signal may be placed in the same subframes as containing the primary and secondary synchronization signal. In one embodiment, the reference signal is transmitted on two consecutive subframes. For example, in a TDD LTE system, the SSS is transmitted on the last OFDM symbol of subframe zero and subframe five, while the PSS is transmitted on the third symbol of subframe one and subframe six. In this example, a transmitter may transmit the reference signal in any OFDM symbol between the SSS and the PSS. It is realized that this will typically not increase the duty cycle of the transmitter since it may not be able to be turned ON/OFF during such a short period as 3 OFDM symbols. If the reference signal is transmitted in at least two consecutive subframes, one of the subframes could be a special subframe containing a DwPTS region, and the reference signal might be transmitted in the special subframe. In an example, the special subframe may be the only subframe that the reference signal is transmitted in.

A further aspect of the invention involves providing improved synchronization for receivers in a TDD system. During subframes for uplink transmission, the receiver will not be able to receive the downlink reference signal. Hence, it may not be able to adjust the synchronization until a downlink subframe is received.

In another embodiment, a reference signal is transmitted immediately after a receiver, such as a UE, switches from uplink transmission to downlink reception. Table 1 below illustrates some downlink (DL) and uplink (UL) configurations. In Table 1, a “U” refers to an uplink subframe, a “D” refers to a downlink subframe, and an “S” refers to a special subframe. An LTE system may switch from uplink to downlink every 5 ms or every 10 ms. In an example, an LTE system switches from uplink to downlink in subframe zero and subframe five. In other examples, the system switches from uplink to downlink in subframe four and subframe nine, or subframe three and subframe eight. In an embodiment, a transmitter transmits a reference signal on subframes zero and five. Similarly, for a configuration where subframe four and subframe nine occur in a downlink frame after an uplink frame, an embodiment transmitter transmits a reference signal in subframes four and nine. However, in another embodiment, the transmitter may transmit a reference signal in subframe three and subframe eight. In another example, the reference signal is transmitted only on subframe four, only on subframe five, or only on subframe three. Alternately, the transmitter transmits the reference signal in subframes five and nine. In one example, the reference signal is transmitted in the subframe immediately after a switch from uplink transmission to downlink transmission, where the reference signal is also transmitted 5 ms after the switch. Hence, at least one of the subframes in the subset would be preceded by an uplink subframe. In an example, the subset that the reference signal is transmitted in has a periodicity of 5 ms, i.e., the separation in time of two subframes in the subset is 5 ms. Alternately, the subset that the reference signal is transmitted in has a periodicity of 10 ms.

TABLE 1
UL/DL configurations

| Downlink-to-Uplink | Subframe number | | | | | | | | | |
|---|---|---|---|---|---|---|---|---|---|---|
| Switch-point periodicity | 0 | 1 | 2 | 3 | 4 | 5 | 6 | 7 | 8 | 9 |
| 5 ms | D | S | U | U | U | D | S | U | U | U |
| 5 ms | D | S | U | U | D | D | S | U | U | D |
| 5 ms | D | S | U | D | D | D | S | U | D | D |
| 10 ms | D | S | U | U | U | D | D | D | D | D |
| 10 ms | D | S | U | U | D | D | D | D | D | D |
| 10 ms | D | S | U | D | D | D | D | D | D | D |
| 5 ms | D | S | U | U | U | D | S | U | U | D |

One aspect of the invention includes reducing the inter-cell interference of the reference signal. This improves the synchronization performance as the as reference signals from different cells could be made orthogonal, i.e., not use the same set of time-frequency resources.

In one embodiment, different cells coordinate which cell will transmit the reference signal on which subset of subframes, so that different cells transmit the reference signal on different subsets of subframes. For example, a first cell may transmit the reference signal on subframe zero and subframe five, while a second cell transmits the reference signal on subframe one and subframe six, while a third cell transmits the reference signal on subframe two and seven, and so on. For a radio frame consisting of ten subframes, there may thus be at most five subsets comprising two subframes separated by five subframes, which would be orthogonal. A skilled reader may further realize that the number of possible subsets may be different in a TDD system, since some subframes in a radio frame are uplink subframes.

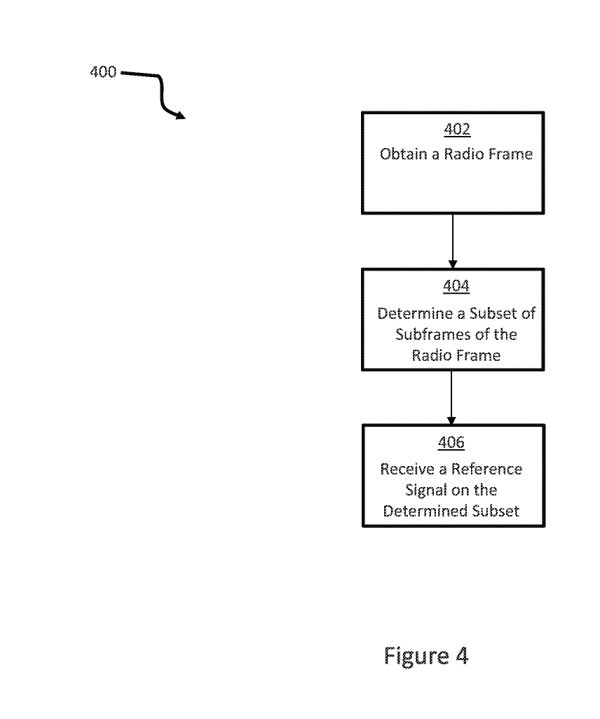

FIG. 4 illustrates flowchart 400 for an embodiment method of receiving a reference signal. Initially, in step 402, the receiver, which may be a UE, obtains a radio frame. Next, in step 404, the receiver determines a subset of subframes of the radio frame that contain a reference signal. The determined subset of subframes in step 404 is similar to the determined subset of subframes in step 304. Finally, in step 406, the receiver receives a reference signal in the determined subset of subframes.

The receiver should be able to determine the subset of subframes. In an example, the subset of subframes is predetermined. Alternately, information in the determined subset of subframes is conveyed from a transmitter to the receiver by radio resource control (RRC) signaling, medium access control (MAC) signaling, or signaling by a physical downlink control channel (PDCCH) or an enhanced PDCCH. In other examples, an implicit determination in the determined subset of subframes is performed based on other parameters known or detected by the receiver. For example, the determined subset of subframes might be a function of a cell ID, which the receiver detects from the PSS and the SSS.

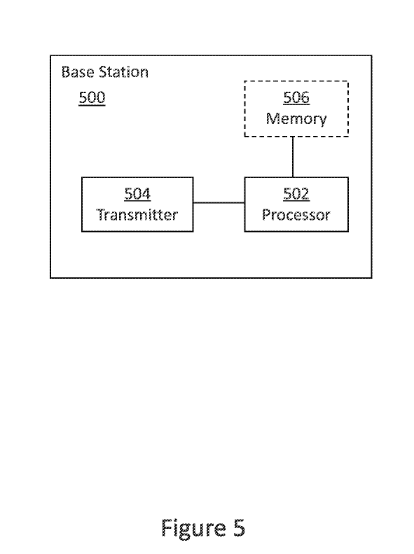

FIG. 5 illustrates embodiment base station 500, which is configured to transmit a reference signal. Base station 500 includes base station processor 502, transmitter 504, and base station memory 506. In an example, base station memory 506 programming containing instructions to be run on base station processor 502. Based on these instructions, base station processor 502 determines a subset of subframes of a radio frame to transmit a reference signal on, and transmitter 504 transmits determined subset of, including determined subset of subframes containing the reference signal. The subframes may be determined using step 304 of flowchart 300. In an example, base station memory 506 is also configured to store the subset of subframes that the reference signal is transmitted on. Base station processor 502 may be a microprocessor, a digital signal processor, or an application specific integrated circuit.

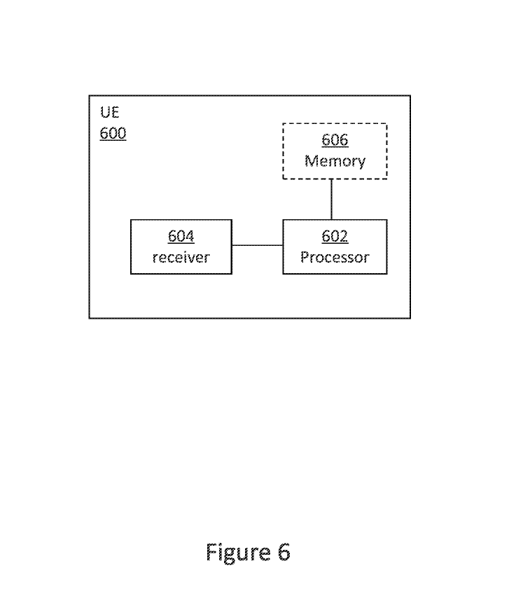

FIG. 6 illustrates embodiment UE 600 which is configured to receive a reference signal. UE 600 includes UE processor 602, receiver 604, and UE memory 606. In an example, receiver 604 is configured to receive a radio frame containing a reference signal on a subset of subframes. UE memory 606 contains programming instructions to be run on UE processor 602, instructing UE processor 602 to determine the subset of subframes of the radio frame that a reference signal is transmitted on, and to instruct receiver 604 to receive the subset of subframes the reference signal is transmitted on. In an embodiment, UE memory 606 is configured to store the subset of subframes that the reference signal is transmitted on.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for transmitting a reference signal in a wireless communications system, the method comprising:
obtaining, by a base station, a radio frame;
determining, by the base station, a first subset of subframes of the radio frame, wherein the first subset comprises a first subframe of the radio frame, and wherein the first subframe comprises a mandatory downlink signal; and
transmitting the reference signal only in the determined first subset.

2. The method of claim 1, wherein the first subframe comprises a primary synchronization signal.

3. The method of claim 2, wherein the first subframe is subframe 0, and wherein the first subset further comprises a second subframe of the radio frame, wherein the second subframe is subframe 5.

4. The method of claim 2, wherein the first subset further comprises a second subframe of the radio frame, wherein the second subframe comprises a secondary synchronization signal.

5. The method of claim 1, wherein the first subframe comprises a signal containing broadcast information.

6. The method of claim 1, wherein the first subframe comprises a secondary synchronization signal.

7. The method of claim 6, wherein the first subframe is subframe 0, and wherein the first subset further comprises a second subframe of the radio frame, wherein the second subframe is subframe 5.

8. The method of claim 1, further comprising transmitting a description of the first subset.

9. The method of claim 1, wherein the first subframe is immediately after an uplink subframe.

10. The method of claim 9, wherein subframes in the first subset further has a subframe period of 5 ms.

11. The method of claim 9, further comprising transmitting a description of the first subset indicating a schedule of the subframes.

12. The method of claim 1, wherein obtaining the radio frame comprises obtaining the radio frame in a first cell, wherein the first subset of subframes of the radio frame is different than a second subset of subframes of a second radio frame in a second cell.

13. The method of claim 12, wherein the first subset comprises subframe 0 and subframe 5, and wherein the second subframe comprises subframe 1 and subframe 6.

14. A base station comprising:
a processor;
a computer readable storage medium storing programming for execution by the processor, the programming including instructions to
obtain a radio frame, and
determine a first subset of subframes of the radio frame, wherein the first subset comprises a first subframe of the radio frame, and wherein the first subframe comprises a mandatory downlink signal; and
a transmitter coupled to the processor, wherein the transmitter is configured to transmit a reference signal in the determined first subset.

15. The base station of claim 14, wherein the first subframe is immediately after an uplink subframe.

16. The base station of claim 14, wherein obtaining the radio frame comprises obtaining the radio frame in a first cell, wherein the first subset of subframes of the radio frame is different than a second subset of subframes of a second radio frame in a second cell.

17. A method for receiving a reference signal in a wireless communications system, the method comprising:
obtaining, by a user equipment, a radio frame;
determining, by the user equipment, a subset of subframes of the radio frame, wherein the subset comprises a first subframe of the radio frame, and wherein the first subframe comprises a mandatory downlink signal; and
receiving the reference signal only in the determined subset.

18. The method of claim 17, further comprising performing synchronization using the reference signal.

19. The method of claim 17, further comprising determining a power of a received signal in the radio frame using the reference signal.

20. The method of claim 17, further comprising measuring a quality of a received signal in the radio frame using the reference signal.

21. The method of claim 17 wherein the first subframe is immediately after an uplink subframe.

22. The method of claim 17, wherein obtaining the radio frame comprises obtaining the radio frame in a first cell, wherein the subset is different than a second subset of subframes of a second radio frame in a second cell.

23. A user equipment comprising:
a processor; and
a computer readable storage medium storing programming for execution by the processor, the programming including instructions to
obtain, by the user equipment, a radio frame,
determine, by the user equipment, a subset of subframes of the radio frame, wherein the subset comprises a first subframe of the radio frame, and wherein the first subframe comprises a mandatory downlink signal, and
receive a reference signal only in the determined subset.
